(19) United States
(12) Patent Application Publication
(10) Pub. No.: US 2015/0242549 A1
(43) Pub. Date: Aug. 27, 2015

(54) METHOD OF CONSTRUCTING SURFACE ROUGHNESS CHANGE MODEL FOR WIND FARM MICRO-SITTING

(71) Applicants: State Grid Corporation of China, Beijing (CN); Gansu Electric Power Company of State Grid, Lanzhou (CN); Wind Power Technology Center of Gansu Electric Power Company, Lanzhou (CN)

(72) Inventors: NING-BO WANG, Beijing (CN); LIANG LU, Beijing (CN); WEN-LING JIANG, Beijing (CN); KUN DING, Beijing (CN); SHI-YUAN ZHOU, Beijing (CN); JIN LI, Beijing (CN); JIN-PING ZHANG, Beijing (CN)

(21) Appl. No.: 14/619,077

(22) Filed: Feb. 11, 2015

(30) Foreign Application Priority Data
Feb. 25, 2014 (CN) 201410064840.4

(51) Int. Cl. G06F 17/50; G06F 17/11

(52) U.S. Cl. CPC G06F 17/5009; G06F 17/11

(57) ABSTRACT

A method of constructing roughness change model for wind farm micro-sitting includes following steps. A roughness change model is established. The roughness change model is resolved. The step of establishing the roughness change model includes that a wind flow from upstream reaches an anemometer tower after being disturbed by two roughness change, and a wind profile of the wind turbine comprises a first portion, a second portion, and a third portion. The first portion is described with a first roughness and a first friction velocity, the second portion is described with a second roughness and a second friction velocity, and the third portion is described with a third roughness and a third friction velocity.

This application claims all benefits accruing under 35 U.S.C. §119 from China Patent Application 201410064840.4, filed on Jan. 25, 2014 in the China Intellectual Property Office, disclosure of which is incorporated herein by reference.

### BACKGROUND

1. Technical Field

The present disclosure relates to a method of constructing surface roughness change model for wind farm micro-sitting.

2. Description of the Related Art

With the rapid development of wind power industry, China has entered a period of rapidly developing wind power. Large-scale wind power bases are usually located in the “Three North” (Northwest, Northeast, Northern China) of China.

The large-scale wind power bases are far away from the load center, thus their electricity need being delivered to the load center for over long distances. Because of the intermittent, randomness, and volatility of the wind resource, the wind power output from the large-scale wind power base will fluctuate in a wide range, which brings a series of problems to the security of power grid. Furthermore, the air flow is affected by the surface roughness around the wind farm, thus it is essential to select the site of the wind farm.

What is needed, therefore, is a method of constructing surface roughness change model for wind farm micro-sitting.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 shows a flowchart of one embodiment of a method of constructing surface roughness change model for wind farm micro-sitting.

FIG. 2 shows a schematic view of one embodiment of development of internal boundary layer of a surface roughness change model during changing the roughness.

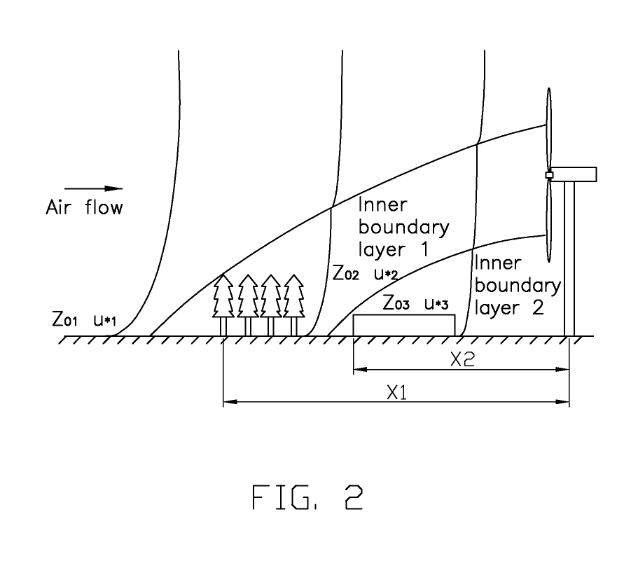

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

The influence to the air flow caused by the change of surface roughness can be described as: during the air flow transfer from a first surface to a second surface, the wind speed profile and friction velocity will be adjusted by the forcing process of the underlying surface. With the air flow running along the direction of downstream, the forcing process of the underlying surface will gradually spread over. Thus a new boundary layer with gradually increased thickness will be formed on the second surface. Finally, the air layer will completely get rid of the air flow and form a new boundary layer suitable for the underlying surface.

During the initial and middle stages of this process, the new boundary layer is called the inner power boundary layer, and short for boundary layer. After being disturbed by the roughness change, the wind profile has following characteristics: while the upstream is neutral atmosphere, the distribution of wind profile above the boundary layer will maintain the logarithmic wind profile at the upstream. Furthermore, the wind profile under the boundary layer is changed according to the roughness and wind speed. Therefore, the entire wind profile expressed as a mosaic relationship.

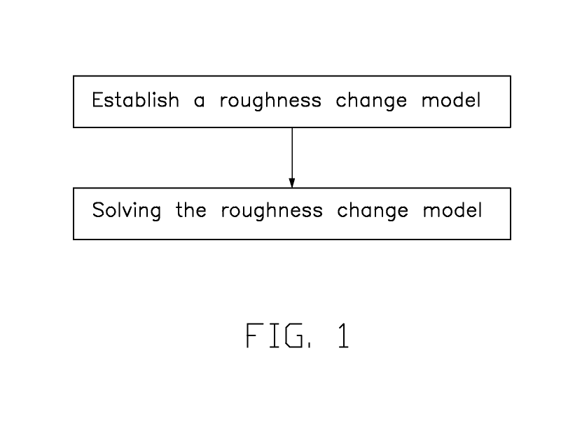

Referring to FIG. 1, one embodiment of a method of constructing roughness change model for wind farm micro-sitting comprising:
step (a), establishing a roughness change model; and
step (b), solving the roughness change model.

In step (a), assuming that the wind flow from upstream reached the anemometer tower after being disturbed by two roughness change, the wind profile of the wind turbines comprises a first portion u₁(z), a second portion u₂(z), and a third portion u₃(z). The first portion u₁(z) can be described with roughness z₀₁ and friction velocity u_{*1}, the second portion u₂(z) can be described with roughness z₀₂ and friction velocity u_{*2}, and the third portion u₃(z), can be described with roughness z₀₃ and friction velocity u_{*3}.

According to the experimental observation and simulation analysis, the wind profile at downstream after air flow flows the two roughness change can be expressed as:

$$u ( z ) = \{ \begin{matrix}{u}^{′} \frac{ln ( z / {z}_{01} )}{ln ( 0.3 h / {z}_{01} )} & z \geq 0.3 h \\ {u}^{″} + ( {u}^{′} - {u}^{″} ) \frac{ln ( z / 0.09 h )}{ln ( 0.3 / 0.09 )} & 0.09 h \leq z \leq 0.3 h \\ {u}^{″} \frac{ln ( z / {z}_{02} )}{ln ( 0.09 h / {z}_{02} )} & z \leq 0.09 h\end{matrix} \qquad ( 1 )$$

wherein z₀₂ is the roughness of analysis position, z₀₁ is the roughness of a position nearest the analysis position; and

$${u}^{′} = ( \frac{{u}_{* 1}}{κ} ) ln ( \frac{0.3 h}{{z}_{01}} ) , \\ {u}^{″} = ( \frac{{u}_{* 2}}{κ} ) ln ( \frac{0.09 h}{{z}_{02}} ) ,$$

wherein u_{*2} is the friction velocity of z₀₁, u_{*1} is the friction velocity of z₀₂, κ=0.4 is Kaman constant, h is the height of the boundary layer and can be determined by:

$$\frac{h}{{z}_{0}^{′}} ( ln \frac{h}{{z}_{0}^{;}} - 1 ) = 0.9 \frac{x}{{z}_{0}^{′}} \qquad ( 2 )$$

wherein Z₀′=max(z₀₁, z₀₂), x is the distance between the analysis position and the roughness change position.

Thus while the friction velocity u_{*2} and u_{*1}, roughness z₀₁ and z₀₂ are obtained, the wind speed of the wind turbines at different height under roughness change can be obtained through formula (1) and (2).

The roughness z₀₁ and roughness z₀₂ can be obtained by evaluating the surface conditions. Thus while the relationship between the friction velocity of wind profile undisturbed at upstream and the friction velocity u_{*2} and friction velocity u_{*1} is established, the difference of flow field at different heights before and after being disturbed by the roughness change can be obtained.

Under roughness change, the relationship between different friction velocities can be expressed as:

$$\frac{{u}_{{ }^{*} n + 1}}{{u}_{{ }^{*} n}} = \frac{ln ( h / {z}_{0 n} )}{ln ( h / {z}_{0 n + 1} )} \qquad ( 3 )$$

wherein z₀ₙ is the roughness at upstream, z₀ₙ₊₁ is the roughness at downstream, u_{*n} is the friction velocity according to z₀ₙ, u_{*n+1} is the friction velocity according to z₀ₙ₊₁.

Furthermore, assuming that the friction velocity of wind profile at upstream is u_{*}^{assu}, the friction velocity u_{*2} and u_{*1} can be expressed through u_{*}^{assu} based on formula (3). Thus the wind speed at anemometer tower measured at different height can be expressed through u_{*}^{assu} based on formula (1) and (2). The flow field change can be obtained by comparing the wind speed at anemometer tower with the wind speed which is undisturbed.

The far the roughness change position away from the analysis position, the weaker the effect. Thus a distance weight factor can be added to represent the effect of distance:

$${z}_{0 neffe} = {z}_{0 n + 1} \times {( \frac{{z}_{0 n}}{{z}_{0 n + 1}} )}^{{w}_{n}} \qquad ( 4 )$$

wherein z_{0effe} is equivalent roughness;

$${W}_{n} = exp ( - \frac{{x}_{n}}{D} )$$

is the distance weight factor of the nₜₕ roughness; D=10 kilometers, which means that the roughness change will not affect the wind profile away from 10 kilometers.

In step (b), the disturbance of the non-homogeneous underlying surface to the undisturbed flow field at upstream can be evaluated through a speed growth factor. The speed growth factor can be defined as: at the same height of underlying surface, a ratio between the undisturbed wind speed at upstream and the difference of the disturbed wind speed at downstream and the undisturbed wind speed at upstream shown as below:

$$Δ S = \frac{U - {U}_{0}}{{U}_{0}} = \frac{{U}^{′}}{{U}_{0}} . \qquad ( 5 )$$

In step (b), the step of analyzing the flow field disturbance with the roughness change model can be performed as:

(b1), calculating equivalent roughness z_{0effe} based on formula (4), wherein the research range ranges from the anemometer tower to the edge which 10 kilometers from the anemometer tower;

(b2), assuming that u_{*}^{assu} is a unit vector, and obtaining undisturbed wind speed at wind turbine based on equivalent roughness z_{0effe} and logarithmic wind profile;

(b3), calculating friction velocity U_{*2}, u_{*1}, based on formula (3) and calculating the height h of the inner power boundary layer based on formula (2);

(b4), determining the expression of the disturbed wind speed at anemometer tower based on formula (1); and (b5), obtaining the speed growth factor by calculating the disturbed wind speed based on formula (5).

According to the analysis principle of the disturbance of the flow field caused by the roughness change, the calculated result of the roughness change model is a plurality of speed growth factors corresponding to the plurality of wind turbines. During resolving the speed growth factors, the effect of roughness change to the flow field is independent from flow field. Thus at a given location, while the distribution of surface roughness remains unchanged, the disturbance to the flow field caused by the surface roughness is determined by the speed growth factor.

Furthermore, the wind speed at the anemometer tower is affected by the roughness change along different direction, thus the effect of the roughness should be divided into a plurality of sections. In each of the plurality of sections, the effect of the roughness change is analyzed with same analysis method.

The method of constructing surface roughness change model for wind farm micro-sitting has following advantages. It is convenient for wind farm sitting based on the surface roughness change model. Thus the defect of low in stability and hard to siting in prior art can be overcome.

Depending on the embodiment, certain of the steps of methods described may be removed, others may be added, and that order of steps may be altered. It is also to be understood that the description and the claims drawn to a method may include some indication in reference to certain steps. However, the indication used is only to be viewed for identification purposes and not as a suggestion as to an order for the steps.

It is to be understood that the above-described embodiments are intended to illustrate rather than limit the disclosure. Variations may be made to the embodiments without departing from the spirit of the disclosure as claimed. It is understood that any element of any one embodiment is considered to be disclosed to be incorporated with any other embodiment. The above-described embodiments illustrate the scope of the disclosure but do not restrict the scope of the disclosure.

What is claimed is:

1. A method of constructing roughness change model for wind farm micro-sitting, the method comprising:
step (a), establishing a roughness change model; and
step (b), solving the roughness change model.

2. The method of claim 1, wherein establishing the roughness change model comprises:
assuming a wind flow from upstream reach an anemometer tower after being disturbed by two roughness changes, a wind profile of the wind turbine comprises a first portion u₁(z), a second portion u₂(z), and a third portion u₃(z); the first portion u₁(z) is described with a first roughness z₀₁ and a first friction velocity u_{*1}, the second portion u₂(z) is described with a second roughness z₀₂ and a second friction velocity u_{*2}, and the third portion u₃(z) is described with a third roughness z₀₃ and a third friction velocity u_{*3}.

3. The method of claim 2, wherein according to experimental observation and simulation analysis, the wind profile at downstream after air flow flows the two roughness changes is expressed as:
$$u ( z ) = \{ \begin{matrix}{u}^{′} \frac{ln ( z / {z}_{01} )}{ln ( 0.3 h / {z}_{01} )} & z \geq 0.3 h \\ {u}^{″} + ( {u}^{′} - {u}^{″} ) \frac{ln ( z / 0.09 h )}{ln ( 0.3 / 0.09 )} & 0.09 h \leq z \leq 0.3 h \\ {u}^{″} \frac{ln ( z / {z}_{02} )}{ln ( 0.09 h / {z}_{02} )} & z \leq 0.09 h\end{matrix} ; \\ {u}^{′} = ( \frac{{u}_{* 1}}{κ} ) ln ( \frac{0.3 h}{{z}_{01}} ) , \\ {u}^{″} = ( \frac{{u}_{* 2}}{κ} ) ln ( \frac{0.09 h}{{z}_{02}} ) ,$$
wherein κ=0.4 is Kaman constant, h is the height of the boundary layer.

4. The method of claim 3, wherein a height h of the boundary layer is calculated by:
$$\frac{h}{{z}_{0}^{′}} ( ln \frac{h}{{z}_{0}^{;}} - 1 ) = 0.9 \frac{x}{{z}_{0}^{′}} ;$$
wherein z₀′=max(z₀₁,z₀₂), x is a distance between the analysis position and location of roughness change.

5. The method of claim 4, wherein the first roughness z₀₁ and the second roughness z₀₂ are obtained by evaluating surface conditions.

6. The method of claim 5, wherein a relationship between the friction velocity of wind profile undisturbed at upstream and the second friction velocity u_{*2} and first friction velocity u_{*1} is established, a difference of flow field at different heights before and after being disturbed by the roughness change is obtained.

7. The method of claim 6, wherein under roughness change, the relationship between different friction velocities is expressed as:
$$\frac{{u}_{{ }^{*} n + 1}}{{u}_{{ }^{*} n}} = \frac{ln ( h / {z}_{0 n} )}{ln ( h / {z}_{0 n + 1} )} ;$$
wherein z₀ₙ is the roughness at upstream, z₀ₙ₊₁ is the roughness at downstream, u_{*n} is the friction velocity according to z₀ₙ, and u_{*n+1} is the friction velocity according to z_{0n+1.}

8. The method of claim 7, wherein assuming the friction velocity of wind profile at assu upstream is u_{*}^{assu}, the first friction velocity u_{*2} and the second friction velocity u_{*1} is expressed through u_{*}^{assu}; the wind speed at anemometer tower measured at different height is expressed through u_{*}^{assu}; and the flow field change is obtained by comparing the wind speed at anemometer tower with the wind speed which is undisturbed.

9. The method of claim 8, wherein a distance weight factor is added to represent the effect of distance:
$${z}_{0 neffe} = {z}_{0 n + 1} \times {( \frac{{z}_{0 n}}{{z}_{0 n + 1}} )}^{{w}_{n}} ;$$
wherein z_{0effe} is equivalent roughness; and
$${W}_{n} = exp ( - \frac{{x}_{n}}{D} )$$
is the distance weight factor of the nₜₕ roughness; D=10 kilometers.

10. The method of claim 9, wherein the disturbance of non-homogeneous underlying surface to undisturbed flow field at upstream is evaluated through a speed growth factor; and the speed growth factor is defined as: at the same height of underlying surface, a ratio between the undisturbed wind speed at upstream and the difference of the disturbed wind speed at downstream and the undisturbed wind speed at upstream shown as below:
$$Δ S = \frac{U - {U}_{0}}{{U}_{0}} = \frac{{U}^{′}}{{U}_{0}} .$$

11. The method of claim 10, wherein analyzing the flow field disturbance with the roughness change model is performed as:
(b1), calculating equivalent roughness z_{0effe}, wherein a research range ranges from the anemometer tower to an edge 10 kilometers from the anemometer tower;
(b2), assuming that u_{*}^{assu} is a unit vector, and obtaining undisturbed wind speed at wind turbine based on equivalent roughness z_{0effe} and logarithmic wind profile;
(b3), calculating the second friction velocity u_{*2}, the first friction velocity u_{*1} and calculating the height h of the inner power boundary layer;
(b4), determining an expression of the disturbed wind speed at anemometer tower; and
(b5), obtaining the speed growth factor by calculating the disturbed wind speed.
